(19) United States
(12) Patent Application Publication
(10) Pub. No.: US 2010/0198598 A1
(43) Pub. Date: Aug. 5, 2010

(54) Speaker Recognition in a Speech Recognition System

(75) Inventors: Tobias Herbig, Ulm (DE); Franz Gerl, Neu-Ulm (DE)

Correspondence Address: Sunstein Kann Murphy & Timbers LLP, 125 SUMMER STREET, BOSTON, MA, 02110-1618, US

(73) Assignee: NUANCE COMMUNICATIONS, INC., Burlington, MA (US)

(21) Appl. No.: 12/699,975

(22) Filed: Feb. 4, 2010

(30) Foreign Application Priority Data
Feb. 5, 2009 (EP) 09001624.7

(51) Int. Cl. G10L 15/00; G10L 17/00

(52) U.S. Cl. 704/240; 704/250; 704/242; 704/E15.001; 704/E15.027; 704/E17.002

(57) ABSTRACT

A method for recognizing a speaker of an utterance in a speech recognition system is disclosed. A likelihood score for each of a plurality of speaker models for different speakers is determined. The likelihood score indicating how well the speaker model corresponds to the utterance. For each of the plurality of speaker models, a probability that the utterance originates from that speaker is determined. The probability is determined based on the likelihood score for the speaker model and requires the estimation of a distribution of likelihood scores expected based at least in part on the training state of the speaker.

### PRIORITY

The present application claims priority from European Patent Application No. 09001624.7 filed on Feb. 5, 2009 entitled “Speaker Recognition”, which is incorporated herein by reference in its entirety.

### TECHNICAL FIELD

The present invention relates to a method of recognizing a speaker of an utterance in a speech recognition system, and in particular to a method of recognizing a speaker which uses a number of trained speaker models in parallel. The invention further relates to a corresponding speech recognition system.

### BACKGROUND ART

Recently, a wide variety of electronic devices are being equipped with a speech recognition capability. The devices may implement a speaker independent or a speaker adapted speech recognition system. With a speaker adapted system, higher recognition rates are generally achieved, the adaptation of a speaker model requires the user to speak a certain number of predetermined sentences in a training phase. Such a training phase is inconvenient for a user and often impractical, for example in an automotive environment where a new user wants to give a voice command without delay. Further, plural users may use the speech recognition system, and accordingly, the system has to use the correct speaker adaptation. It is thus desirable to automatically recognize the speaker of an utterance in a speech recognition system. Further, it is desirable that the system quickly adapts to a new speaker if the speaker changes.

DE 10 209 324 C1 describes a method for fast speaker adaptation in a speech recognition system. Plural speaker dependent models or codebooks are used in parallel to a standard codebook. By using the standard codebook, a list of the n-best matching normal distributions is determined. On the same set of normal distributions, the likelihood of the speaker dependent codebooks is approximated and the inverse is used as a means for determining a speaker change.

Further, systems are known in the art which use Hidden Markov Models for combining a speaker change and speaker dependent emission probabilities in a statistical model. Each state of the Hidden Markov Model (HMM) corresponds to a speaker, and each emission probability distribution corresponds to a classical Gaussion Mixture Model (GMM). The probability of a speaker change is then modelled by a Bayesian Information Criterion (BIC). Further, systems are known which use Neutral Networks (NNs) which are trained for being capable of distinguishing different speakers.

A problem of these systems is that they are configured for a predetermined number of speakers. If another speaker is to be added, the whole system needs to be retrained. For training the system, utterances of all speakers have to be available. Such an approach is generally not practical. Further, if a new speaker is added to a speech recognition system using different codebooks adapted to different speakers, the new codebook for the new speaker is on a different training level. The inventors of the present invention have recognized that by comparing likelihood scores obtained for the classification of feature vectors of an utterance on differently trained codebooks, the reliability of the speaker recognition is greatly reduced. By using the currently available methods, the speaker of an utterance cannot reliably be determined if codebooks of different training states are used. The distinction of different speakers is particularly difficult if the codebooks for new speakers originate from the same standard codebook.

For improving the recognition rate of a speech recognizer, it is desirable that the speech recognition system reliably recognizes a registered speaker and is capable of adapting to a new speaker. To improve the recognition rate, it is further desirable to adapt speaker specific codebooks to the speaker during the runtime of the system. Further, the speech recognition system should run in realtime and should not require to run a separate speaker recognition algorithm, i.e. it is desirable to integrate speech recognition and speaker recognition. First recognizing a speaker of an utterance and then recognizing the utterance itself leads to an undesirable delay.

Accordingly, if an utterance is decoded, a first estimation of the identity of the speaker is necessary to use the correct codebook for decoding. As such an estimation may be rather inaccurate, a fast change of the codebook used for decoding should be allowed. It is further desirable to adapt the extraction of feature vectors from the utterance to the speaker of the utterance, which requires a more reliable estimate of the originator of the utterance. To further improve the speech recognition performance of the system, it is desirable to perform a training of the speaker models or codebooks, i.e. to further adapt the codebook to the corresponding speaker. If the training of the codebook is performed on an utterance originating from another speaker, the speech recognition performance of the system will deteriorate. Accordingly, it is important to recognize the speaker of an utterance with a high confidence.

### SUMMARY OF THE INVENTION

There is a need for providing an improved method of recognizing a speaker, which is capable of reliably recognizing a speaker and of adding new speakers.

According to a first aspect of the invention, a method of recognizing a speaker of an utterance in a speech recognition system is provided. The method comprises the steps of comparing the utterance to a plurality of speaker models for different speakers, determining a likelihood score for each speaker model, the likelihood score indicating how well the speaker model corresponds to the utterance, and, for each speaker model, determining a probability that the utterance originates from the speaker corresponding to the speaker model. The determination of the probability for a speaker model is based on the likelihood scores for the speaker models and takes a prior knowledge about the speaker model into account.

Such a prior knowledge may for example be a probability of the codebook generating a certain likelihood score if the speaker corresponding to the speaker model is or is not the originator of the utterance. As the probability not only considers the comparison between the utterance and the speaker model, but also the prior knowledge, it is a better measure for determining the originator of the utterance. By using the probability instead of the likelihood score, the originator of the utterance can more reliably be determined. The originator may be determined as the speaker corresponding to the speaker model being associated with the highest probability.

According to an embodiment, the prior knowledge for a particular speaker model may comprise at least one of an expected distribution of likelihood scores for the particular training state of the speaker model and an expected distribution of likelihood scores for the particular speaker model. The likelihood score distribution for the training state may for example be an average distribution for different speaker models of the same training state. The use of a distribution of likelihood scores expected for the particular speaker model in the determination of the probability for the speaker model may yield even more reliable probabilities. The determination of the probability for a particular speaker model may also consider the training states of all other speaker models.

Taking the prior knowledge into account may for example comprise an estimation of a distribution of likelihood scores expected for a training state of the speaker model and comparing the likelihood score determined for the speaker model to the likelihood score distribution expected for the training state of the speaker model. A probability may thus be obtained indicating how likely it is that the speaker model attracts a certain likelihood score if the corresponding speaker was the originator of the utterance. That way, the training state of the speaker model can be considered when determining the probability and the speaker can be recognized more reliably.

The distribution of likelihood scores expected for the training state may be estimated by a multilayer perceptron trained on likelihood score distributions obtained for different training states of speaker models, wherein the multilayer perceptron returns parameters of a distribution of likelihood scores for the given particular training state. The distribution may for example be a normal distribution which is characterized by a mean value (μ) and a variance (Σ). These parameters may for example be returned by the multilayer perceptron (MLP), when it receives the training state as an input. Using the known distribution, which indicates how probable it is to obtain a particular likelihood score for speaker model of the given training state, the likelihood score determined for the utterance can easily be converted into a probability.

According to another embodiment, taking the prior knowledge into account comprises estimating a distribution of likelihood scores expected for the particular speaker model or for the gender of the speaker corresponding to the speaker model and comparing the likelihood score determined for the speaker model to the likelihood score distribution expected for said speaker model. The likelihood score distribution may for example be a normal distribution characterized by the mean or average μ, or the variance Σ, which can be characteristic for a particular speaker. By comparing the obtained likelihood score to such a distribution, the probability for the speaker model can reliably be determined. It should be clear that information on the likelihood score distribution expected for particular speaker and expected for the training state of the model can be combined, for example by providing a distribution for each speaker model for a particular training state. Likelihood score distributions characteristic to a particular gender may also be employed. Even in difficult situations, e.g. when microphones used to record the utterance are changed, a reliable speaker identification is thus still enabled.

The estimation of the distribution of likelihood scores may further consider at least one of a length of the utterance and a signal to noise ratio of the utterance. These factors may cause a change of the absolute likelihood score determined for a speaker model for the utterance, and taking them into account can thus improve the accuracy of the determined probability.

In more detail, the determining of the probability for a particular speaker model may be performed as follows. The likelihood score for the speaker model under consideration may be compared to a distribution of likelihood scores for the particular speaker model expected in case that the speaker under consideration is the originator of the utterance, the distribution of likelihood scores being determined based on said prior knowledge. Further, the likelihood scores for the remaining speaker models may each be compared to a distribution of likelihood scores expected in case that the remaining speaker is not the originator of the utterance, the distribution of likelihood scores for the remaining speakers being again based on the prior knowledge. The probability for the particular speaker model may then be determined based on both comparisons. By also considering a likelihood distribution expected for the remaining or “competing” speakers, a precise determination of the probability can be achieved. Accordingly, two likelihood score distributions can be provided for each speaker model as prior knowledge, one indicating the likelihood scores expected for the speaker model being the actual speaker (assumed speaker), and one for the speaker model not being the actual speaker (competing speakers). If the assumed speaker is not the actual speaker of the utterance, a low probability will thus be obtained, whereas if the assumed speaker is the actual speaker, a high probability will be obtained. It should be clear that for the same training state of a number of speaker models, only one likelihood score distribution may be provided for each of the assumed speaker case and the competing speaker case. It is also possible to provide two distributions for each individual speaker model.

The determination of the probability for a speaker model may further consider a transition probability for a transition between the corresponding speaker to a speaker of a preceding and/or subsequent utterance. Such a transition probability can be particularly useful when used for determining a sequence of speakers. It can be used for fine-tuning the system, i.e. by making it more stable by enabling fewer speaker changes, or by enabling a faster adaption by allowing more frequent speaker transitions. Such a transition probability may further be used to consider external information. The transition probability may for example consider at least one of a change of a direction from which successive utterances originate, a shut-down or restart of the speech recognition system between successive utterances, a detected change of a user of the speech recognition system and the like. The direction from which an utterance is recorded may for example be determined by using a Beamforming Microphone Array. If the direction changes, it is likely that the speaker also changes, which may be considered in the transition probability. If the speech recognition system is for example installed in a vehicle, a driver change is likely after a shut-down of the vehicle and the speech recognition system, which may again be considered in the transition probability.

The determination of the likelihood score for a speaker model for the utterance may be based on likelihood scores of a classification of feature vectors extracted from the utterance on the speaker model, wherein the classification result for at least one speaker model may be used in a subsequent speech recognition step. Accordingly, a parallel processing of the utterance for speech recognition and speaker recognition can be avoided. Information obtained from the feature vector classification step of the speech recognition may also be used for the speaker recognition. The speaker models may for example be codebooks comprising multivariate normal distributions for the classification of feature vectors of an utterance (also called feature vector quantisation).

As an example, the utterance may be processed continuously, with the classification result of the speaker model yielding the highest average likelihood score for a predetermined number of feature vectors being supplied to the speech recognition step. A moving average may for example be used to average a certain number of likelihood scores for each speaker model. The result of the speaker model with the highest average can then be used for the speech recognition step. A fast change between speaker models or codebooks during speech recognition can thus be realized, resulting in an improved speech recognition.

According to a further embodiment, the utterance may be part of a sequence of utterances, wherein the probability is determined for each utterance in the sequence, the method further comprising a determining of a sequence of speakers having the highest probability of corresponding to the sequence of utterances, the determination being based on the probabilities determined for the speaker models for the utterances. Each probability for a speaker model for an utterance may further consider a transition probability for a transition to a speaker of a preceding utterance and/or a speaker of a subsequent utterance. By using such an approach, the actual speaker of an utterance can more reliably be determined, as not only the probability determined for an utterance is taken into account, but also transitions between speakers of the preceding and/or subsequent utterance. As mentioned above, the transition probability may consider external information.

The most probable sequence of speakers corresponding to the sequence of utterances may be determined by using a Viterbi search algorithm based on the probabilities determined for the speaker models for the utterances. Yet it is also possible to use a forward-background decoding algorithm to determine the most probable sequence of speakers corresponding to the sequence of utterances. It should be clear that other algorithms, such as a simple forward decoding, or simple backward decoding, or any other suitable algorithm may be used as well.

The method may further comprise a step of using an utterance of the sequence of utterances to train the speaker model of the speaker in the sequence of the speakers corresponding to the respective utterance. Such an automated training of the speaker models should only be performed if the speaker of an utterance can be determined with high confidence, as the speaker models may otherwise deteriorate. As the determining of the speakers based on a sequence of utterances achieves a high reliability, such a training is rendered possible. Training may for example occur by adapting multivariate distributions of a codebook corresponding to the speaker model to the respective utterance. The training may for example be performed after the sequence of speakers is determined for a predetermined number of successive utterances. Performing the training only after a delay of several utterances ensures that speaker models are trained with utterances of the correct speaker. The training may also directly occur if the probability for a speaker model for an utterance exceeds a predetermined threshold value. The probability itself may thus already indicate a high confidence in speaker identification, and the utterance may thus directly be used for speaker model training. On the other hand, even if a speaker of an utterance is determined based on a sequence of utterances, a training may not be performed if the corresponding probability is below a certain threshold value. An automatic training and improvement of the speaker models can thus be achieved.

The comparing of the utterance to a plurality of speaker models may comprise an extraction of feature vectors from the utterance, wherein the method may further comprise the step of adapting the feature vector extraction in accordance with the speaker model for which the highest probability is determined. The adaptation of the feature vector extraction can be made more reliable if it is based on the probability, and not on the likelihood scores. As an example, the mean value normalization and the energy/power determination may be adapted.

The plurality of speaker models may comprise a standard speaker model, wherein the determination of the speaker model probabilities for the utterance may be based on likelihood scores for the speaker models normalized by a likelihood score for the standard speaker model. Normalization of the absolute likelihood values by the likelihood value for the standard speaker model may reduce statistic correlations between the speaker models. Such correlations may occur as the speaker models may be derived by adapting the standard speaker model. Compensating these statistic dependencies has the advantage that the probability can more reliably be determined.

According to a further embodiment, the determining of a probability for each speaker model may comprise the determining of a probability for an unregistered speaker for which no speaker model exists, the probability being calculated by assuming that none of the speakers of the speaker models originated the utterance. The method may then further comprise the step of generating a new speaker model for the unregistered speaker, if the probability for the unregistered speaker exceeds a predetermined threshold value or exceeds the probabilities for the other speaker models. As an example, the probability for the unregistered speaker may be determined by comparing the likelihood scores for the existing speaker models with likelihood score distributions for the “competing speaker” case. If all these comparisons achieve high probabilities, this may indicate that none of the speakers of the registered speaker models is actually the originator of the recorded utterance. If such a high probability is determined for this case, then a new speaker model can be generated. By using a predetermined threshold value which the probability for the unregistered speaker has to exceed before creating a new speaker model, an unnecessary and excessive creation of speaker models can be prevented.

Other possibilities of making a decision regarding the creation of a new speaker model exist. If the likelihood scores for the speaker models are below a predetermined threshold value, a new speaker model may be generated. On the other hand, a new speaker model may be generated if normalized likelihood scores for the speaker models are below the threshold value.

The plurality of speaker models may comprise for at least one speaker different models for different environmental conditions. The generation of new codebooks may for example be allowed for the same speaker for different environmental conditions. These may occur if the speech recognition system is provided in a portable device, which may e.g. be operated inside a vehicle, outside a vehicle and in a noisy environment. Using these additional speaker models has the advantage that the feature vector extraction and the feature vector classification can be adapted to the particular environmental conditions, resulting in a higher speech recognition accuracy.

According to another aspect of the present invention, a speech recognition system adapted to recognize a speaker of an utterance is provided. The speech recognition system comprises a recording unit adapted to record an utterance, a memory unit adapted to store a plurality of speaker models for different speakers, and a processing unit. The processing unit is adapted to compare the utterance to the plurality of speaker models, to determine a likelihood score for each speaker model, the likelihood score indicating how well the speaker model corresponds to the utterance, and, for each speaker model, to determine a probability that the utterance originates from the speaker corresponding to the speaker model, wherein the determination of the probability for a speaker model is based on the likelihood scores for the speaker models and takes a prior knowledge about the speaker model into account. Such a speech recognition system achieves advantages similar to the ones outlined above.

According to an embodiment, the speech recognition system is adapted to perform one of the methods mentioned above.

According to a further aspect of the invention, a computer program product that can be loaded into the internal memory of a computing device is provided, said product comprising software code portions for performing one of the above mentioned methods when the product is executed. The computer program product may be provided on a data carrier. According to a further aspect, an electronically readable data carrier with stored electronically readable control information is provided, the control information being configured such that when using the data carrier in a computing device, the control information performs one of the above mentioned methods. The computing device may for example be a portable or stationery electronic device comprising the speech recognition system.

It is to be understood that the features mentioned above and those yet to be explained below can be used not only in the respective combinations indicated, but also in other combinations or in isolation, without leaving the scope of the present invention.

### BRIEF DESCRIPTION OF THE DRAWINGS

The foregoing features of the invention will be more readily understood by reference to the following detailed description, taken with reference to the accompanying drawings, in which:

FIG. 1 is a flow-diagram giving an overview of a method according to an embodiment of the invention.

FIG. 2 is a flow-diagram illustrating step 100 of FIG. 1 in more detail.

FIG. 3 is a flow-diagram illustrating step 200 of FIG. 1 in more detail.

FIG. 4 is a flow-diagram illustrating step 300 of FIG. 1 in more detail.

FIG. 5 is a flow-diagram illustrating the creation of a new codebook for a previously unregistered speaker.

FIG. 6 is a schematic diagram illustrating the determination of a probability for a speaker model for a given utterance, in the method according to the embodiment of FIG. 1.

FIG. 7 is a diagram illustrating a correlation coefficient for a correlation between the training state of a speaker model for an assumed speaker and the training state of a speaker model for a competing speaker.

FIG. 8 shows two diagrams for likelihood score distributions expected for different training states of speaker models, with one diagram giving the distributions expected for competing speakers and the other diagrams giving the distributions expected for an assumed speaker.

FIG. 9 is a diagram illustrating the shift of the mean value of the likelihood score distribution with an increasing training state of the speaker model for a competing speaker and for an assumed speaker.

FIG. 10 is a diagram illustrating the change in variance of the expected likelihood score distributions for an assumed speaker and a competing speaker.

FIG. 11 is a schematic diagram illustrating a Viterbi search for finding a most probable sequence of speakers.

FIG. 12 is a functional block diagram schematically illustrating a speech recognition system according to an embodiment of the invention.

### DETAILED DESCRIPTION OF SPECIFIC EMBODIMENTS

The present invention aims at providing a method which enables a speaker recognition based on a variable number of speaker models in different training states. Further, it should allow the determination of a posteriori probability for each speaker at each point in time. The present invention recognizes that the logarithm of likelihood scores for speaker models for a particular utterance strongly depends on the training status of the speaker model. A conventional comparison of likelihood scores, such as in the maximum likelihood method, does not comprise any information about the confidence of the result of the comparison, as for differently trained speaker models, likelihood differences have to be interpreted differently. As the user adapted speaker models may be derived from the same original standard speaker model, the likelihood values obtained for untrained speaker models will derive less from the standard model than for well trained models.

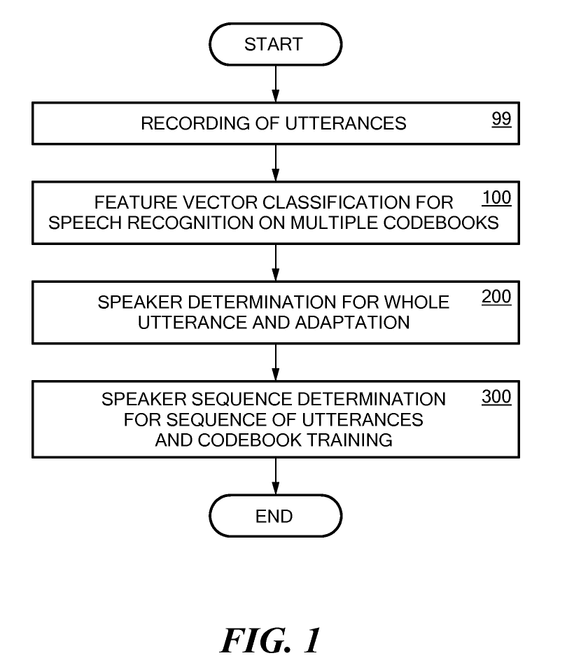

Further, the speaker identification should be integrated into the speech recognition and it should be possible to run the system in realtime. This is achieved by the present invention by providing a speaker recognition on different time scales with different levels of confidence. The processing steps and performance required for speech recognition can be reduced by integrating the speaker recognition into the speech recognition, and not running it in parallel. The different time scales are indicated as steps 100, 200 and 300 in the embodiment of FIG. 1.

In a first step 99 an utterance is recorded and converted into a digital format, e.g. by using a microphone and a standard analogue to digital converter for a sound signal. On a short time scale, a classification of feature vectors extracted from the utterance is performed for enabling a speech recognition on multiple codebooks, i.e. plural speaker models are used in parallel (step 100). A first estimation of the identity of the speaker is used to select the correct codebook for decoding the utterance. As only after processing of the utterance, the speaker can be recognized with a high confidence, a fast change of the codebook used for decoding has to be enabled while processing the utterance. A fast estimation of the identity of the speaker is achieved by performing a first order recursion of the likelihood scores of the individual codebooks. Therefore, each feature vector extracted from the utterance is compared to the codebooks available and an approximation of the likelihood is determined for the current point in time. For the first estimation of the speaker identity, not the whole utterance is considered, but only an average over the scores of a certain number of feature vectors. This may be a moving average or a weighted average. Thereby, it can be prevented that at each time point, i.e. for each feature vector, a different codebook is selected. Still, a fast change between two different codebooks can be achieved.

In step 200, the identity of the speaker is determined based on the whole utterance, and an adaption of the feature vector extraction is performed. As in this point of time, all feature vectors of the utterance are available, and a more reliable estimation of the identity of the speaker is possible as while the utterance is still being decoded. The speaker identification may for example be based on the sum of the logarithms of the likelihood scores of all feature vectors of the utterance, which were used for decoding the utterance. Speaker dependent properties of the feature vector extraction may then be adjusted in accordance with the identified speaker, e.g. a mean value or an energy normalization.

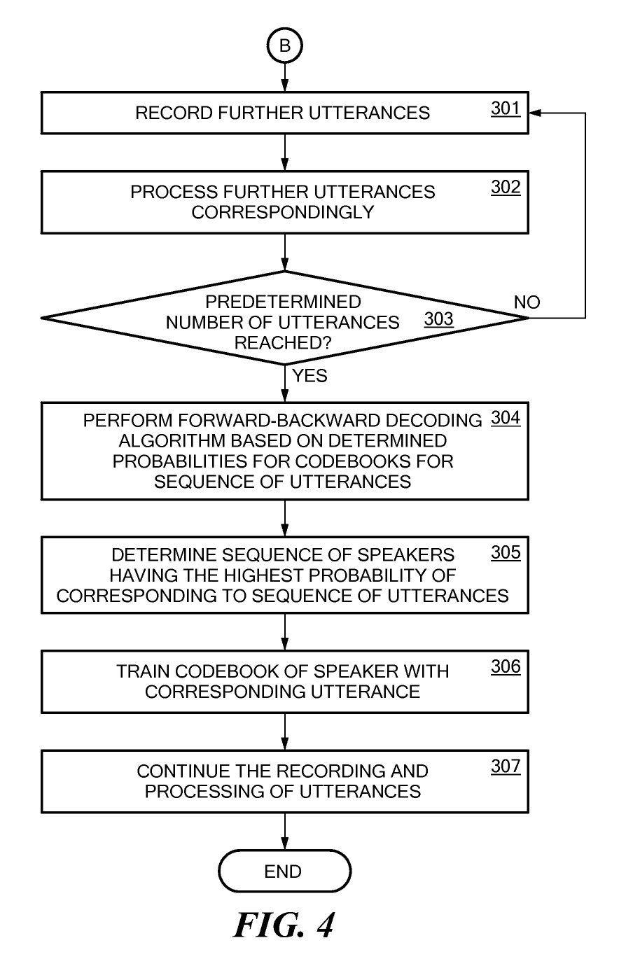

In step 300, a processing on a third time scale spanning several utterances is performed, the processing comprising a determination of a sequence of speakers corresponding to a recorded sequence of utterances, and the training of the speaker models, i.e. the codebooks. On this time scale, the utterances may further be used for creating new codebooks. Errors in the adaptation of the codebooks can have consequences regarding the stability of the speaker identification in the speech recognition system. An incorrect adaptation can result in the mixing of speaker models and accordingly, different speakers can no longer be separated. As for these purposes, the identification of the correct speaker is critical, it is advantageous to base the decision for particular speaker on plural utterances. Further, external information can be integrated at this stage, such as information from a beamforming microphone system, a restart of the speech recognition system and other external knowledge or available information. The determination of the sequence of speakers is further not based on likelihood scores in the present invention, but on probabilities determined for the different speaker models. It thus becomes possible to account for different training states of the speaker models, as well as for individual speakers or environmental situations. By tuning the transition probabilities, the frequency of speaker changes can be limited. The most probable sequence of speakers can be found by using a Viterbi search algorithm, or a forward-backward decoding as described in more detail with respect to FIG. 4. Utterances, for which the speaker has been identified with a high confidence can then be used for training the corresponding speaker model or codebook.

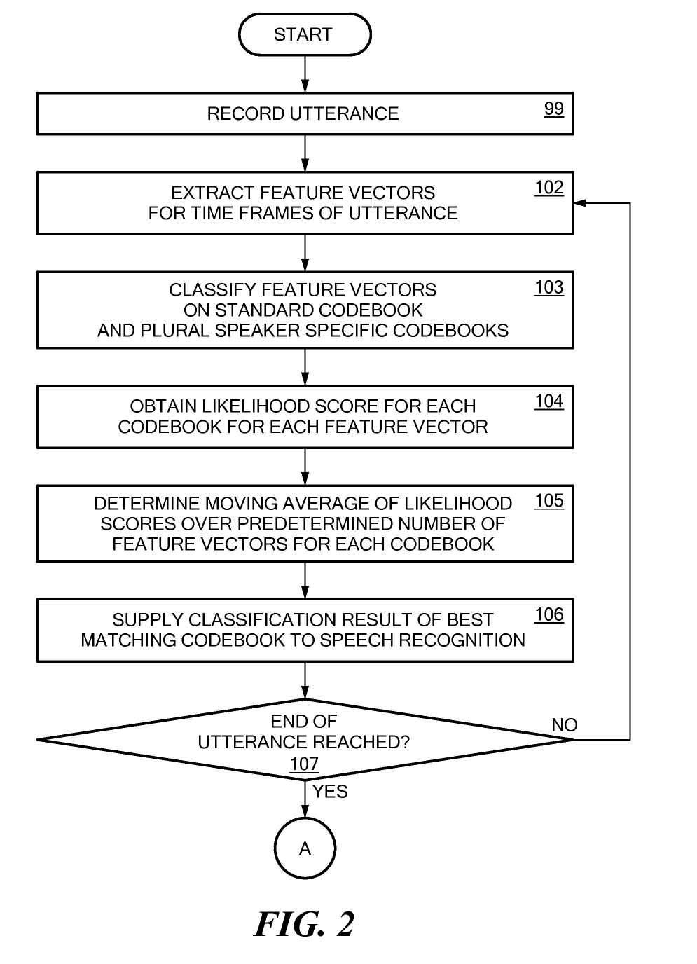

FIG. 2 describes step 100 of the embodiment of FIG. 1 in more detail. After the recording of the utterance in step 99, the utterance is divided into time frames of e.g. ten milliseconds and a feature vector is determined for each time frame in step 102. Characteristic features of the utterance are extracted from the time frame and stored in vector form. For obtaining the feature vector, the time frames, which may overlap, can be transformed by using a Fast Fourier Transformation (FFT) or a Short Time Fourier Transformation (STFT). Further, a noise reduction by Speech Signal Enhancement (SSE) can be performed, for which a Wiener-filter and an estimation of the undisturbed spectrum of the speech may be employed. The powers of the spectrum obtained may then be mapped onto a Mel-Scale. The powers of neighbouring frequency bands are added and the logarithm is taken, and the results are decorrelated by a Discrete Cosine Transform (DCT). Amplitudes of the resulting spectrum are the Mel Frequency Cepstral Coefficients (MFCCs), which can be written as feature vectors xₜ, with a dimension d and a time index t. It should be clear that other methods known in the art for extracting feature vectors from an utterance may be used. For the present invention, it is not important how the feature vectors are extracted.

In the next step 103, the feature vectors are classified on a standard codebook and on plural speaker specific codebooks. The speaker specific codebooks may for example be obtained by adapting the standard codebook to a particular speaker. A codebook can be realized by a Gaussian Mixture Model (GMM). GMMs are particularly well suited in the present context, as they have beneficial properties with respect to an approximation of the distribution density. A Gaussian Mixture Model can be described as a linear combination of multivariate normal distributions. These may be considered as different classes designated by the index i, which are used to classify the feature vectors. Each normal distribution can be defined by the expectation value μᵢ and the covariance matrix Σᵢ·μᵢ and Σᵢ can be considered the parameter set of the class i. For obtaining a linear combination of the classes, each class can be weighted with a weight wᵢ, wherein the sum of the weights wᵢ can be normalized to 1. The parameter set of the GMM which comprises the weights wᵢ and the parameters of the normal distributions is designated as θ. The likelihood for the parameter set θ can then be obtained to

$$l ( {x}_{t} \vert θ ) = {\sum }_{i = 1}^{N} {w}_{i} \cdot {N}_{i} \{ {x}_{t} \vert {μ}_{i} , {\sum }_{i} \} \qquad ( 1 )$$

The GMM can be trained by using an Expectation Maximization (EM) Algorithm, or by using a K-Means method. As an example, the methods described in “Arthur Dempster, Nan Laird, Donald Rubin: Maximum Likelihood From Incomplete Data via the EM Algortihm, Journal of the Royal Statistical Society, Series B, 39(1): 138, 1977” and in “Frank Dellaert: The Expectation Maximization Algorithm, Tutorial, http://www.cc.gatech.edu/dellaert/em-paper.pdf, 2002” may be used. Starting with an initial model θ₀, the feature vector xₜ is assigned to the classes of the models by means of the likelihood. Based on the assignment, the model parameters θ can be recalculated to obtain a new model set θ₁. These steps can iteratively be repeated, until the likelihood as given in equation 1 has reached a maximum value. Such a method is described in more detail in “Douglas A. Reynolds, Richard C. Rose: Robust Text-Independent Speaker Identification Using Gaussian Mixture Speaker Models, IEEE Transactions on Speech and audio Processing, Vol. 3, No. 1, 1995”.

The above described training step is performed only when training or adapting an existing or a newly generated codebook. During speech and speaker recognition the feature vectors are simply classified on the Multivariate Gaussian Distributions of the codebooks. During the classification, a likelihood score is obtained for each codebook of for each feature vector in step 104. As an example, for the standard codebook, a list of the n-best normal distributions achieving the best likelihood values is determined for a feature vector. Based on the same set of normal distributions, the likelihood of the speaker dependent codebooks can be approximated, and the inverse can be used as a measure for recognizing a change of speaker. Such a method of determining likelihood scores is in detail described in DE 10 209 324 C1, which is incorporated herein by reference in its entirety. As an example, for each feature vector, a probability is determined that the feature vector corresponds to a normal distribution of the codebook under consideration. Probabilities above a certain threshold value may then be used for determining the likelihood for the codebook under consideration.

In step 105, a moving average of likelihood scores calculated over a predetermined number of feature vectors is determined for each codebook. As an example, the likelihood scores of the last 100 feature vectors may be added or averaged. It is also possible to weight likelihood values which were obtained further in the past lower than currently obtained likelihood values.

The classification result of the codebook which achieves the highest average likelihood score is then delivered to a speech recognition step in step 106. In the speech recognition step, a decoder may then perform a speech recognition based on the classification results, e.g. by using an acoustic model implementing Hidden Markov Models (HMMs), a vocabulary and a speech model. The result of the speech recognition step may be the identification of an element from a larger list, or a text output in form of a word or a phrase or the like. If for a first part of an utterance, a first codebook achieves high likelihood scores, and for a second part, another codebook achieves high likelihood scores, the codebook which is used for classifying the feature vectors can be changed quickly as a result of step 106. A fast adaptation of the speech recognition system is thus achieved, resulting in an improvement of the recognition rate.

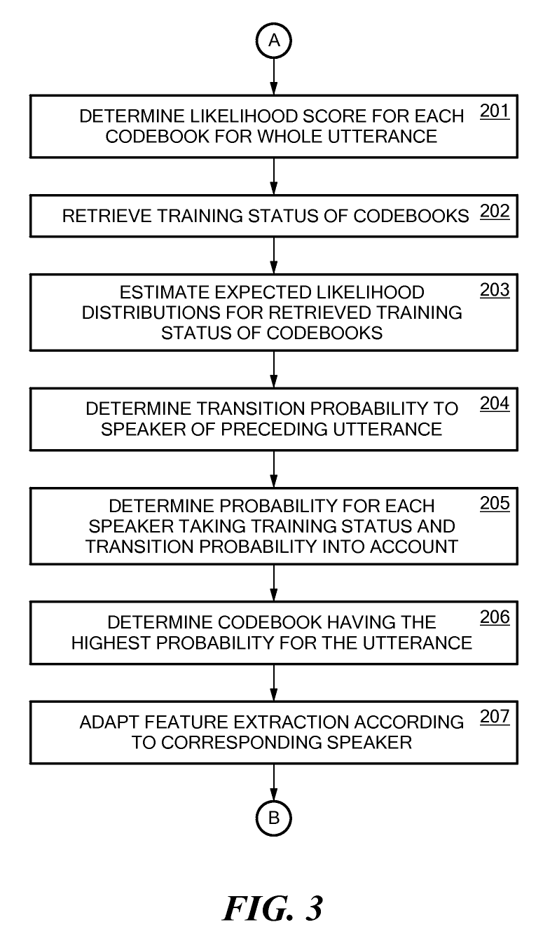

In decision step 107 it is checked whether the end of the utterance has been reached. If the end is not reached, the method continues with step 102 by extracting further feature vectors from the utterance. If the end is reached, the method continues with step 201 of FIG. 3, wherein the whole utterance is considered on a higher time scale.

FIG. 3 illustrates a particular embodiment of step 200 of FIG. 1. For each codebook, a likelihood score for the whole utterance is determined in step 201. As an example, the logarithm of the likelihood values of all feature vectors which were used during decoding is summed for each codebook. Other possibilities include the summation of all likelihood values determined for a particular codebook, or the formation of an average value of all likelihood scores for a codebook.

As mentioned above, likelihood values obtained for a codebook depend on the training state of the particular codebook, and are further correlated to the likelihood scores of the other codebooks, due to their derivation from the same standard codebook. To account for the training status, the training status of the codebooks is retrieved in step 202. In the following, the logarithm of a likelihood score of a speaker model of speaker i for an utterance x at a time t is designated as lᵢ^{s}(xₜ), wherein s indicates the number of utterances to which the speaker model was adapted, i.e. its training status. Note that xₜ designates an utterance in the following, and not a feature vector. The speaker independent standard codebook is generally trained on a large number of utterances, and it is not adapted during the operation of the system, so that its training status is not considered. The likelihood score obtained for an utterance for the standard codebook is designated as l₀ (xₜ). To reduce correlations between speakers, the likelihood scores are normalized to the likelihood score of the standard codebook wherein the logarithmic likelihood difference

lᵢ^{S}^{₁}(xₜ)−l₀(xₜ) (2)

is obtained. The correlations are generally due to the statistical dependencies of the speaker models, which are obtained by an adaptation of the standard codebook, and to the dependency on the actual utterance. By performing the normalization, the dependencies on the actual utterance can be compensated, so that mainly the dependencies on the speaker models remain. Correlation between the likelihood values for the different codebooks, i.e. speaker models, can thus be reduced.

To judge the confidence of a likelihood score obtained for a codebook, the likelihood score is compared to expected likelihood score distributions in the present invention. Although in the following description, the likelihood score will be compared to a distribution specific to a particular training state of a speaker model, it may equally well be compared to any other relevant likelihood score distribution, such as a distribution for a particular speaker, or for a gender of speaker, or for a combination thereof. The expected likelihood score distributions are estimated for the retrieved training status of the codebooks in step 203. Such expected likelihood score distributions, or parameters characterizing such distributions can be stored as prior knowledge in the speech recognition system, or they may be generated during operation of the speech recognition system.

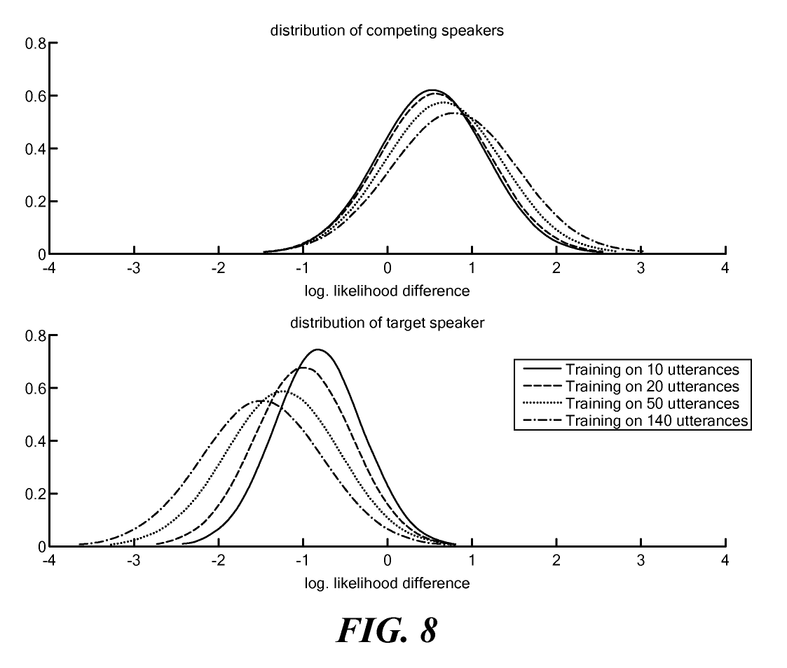

Examples of such expected distributions of likelihood scores are shown in FIG. 8 for different training states of the speaker models (trained with 10, 20, 50 and 140 utterances). The upper part of the figure shows a diagram for the case where the speaker corresponding to the codebook was assumed not to have originated the utterance (competing speaker). The lower part of FIG. 8 shows a diagram where the speaker is assumed to have originated the utterance. The upper diagram shows that for the competing speaker, logarithmic likelihood difference values above 0 are expected, wherein the expectation value of the distribution is shifted towards higher likelihood difference values for higher training states of the codebook. For the lower diagram, i.e. for the assumed or target speaker, difference values below 0 are expected wherein the values are again shifted further away from 0 with an increasing training status. Note that the curves shown in FIG. 8 are an average over the codebooks of 50 speakers, with 50 utterances being tested for each speaker. In FIG. 8, the y-axis indicates the probability of finding a particular likelihood difference. A likelihood difference determined for an utterance during speech recognition for a particular codebook can then be compared to the distribution of FIG. 8 for the training state of the particular codebook. The probability of finding the determined likelihood difference can then be calculated for the case where the speaker corresponding to the codebook is assumed to be the actual speaker, and for the case where it is assumed not to be the actual speaker.

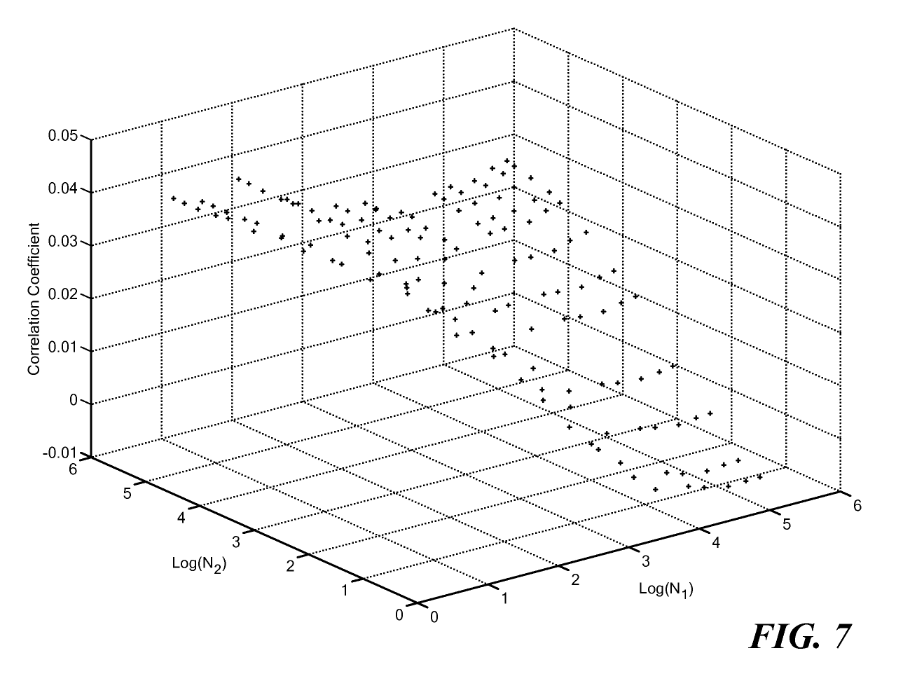

To determine whether the assumed speaker and the non-involved or competing speakers can be modeled by independent statistical models, the statistical dependencies between these were investigated. FIG. 7 shows the covariants between the normalized likelihood scores of an assumed speaker and of a competing speaker as a correlation coefficient. N1 designates the training state of the assumed speaker, and N2 designates the training state of the competing speaker. At relatively low training states, there is only a low correlation between the assumed speaker and the competing speaker. For well-trained models, FIG. 7 shows almost no correlation. Accordingly, independent statistical models can be used for the assumed speaker and the competing speaker.

The curves shown in FIG. 8 for the assumed speaker and the competing speaker can thus be described by independent distributions. As an example, for describing the distribution of the logarithmic likelihood differences of the assumed speaker, a one-dimensional normal distribution with a mean value μ₁=f_{μ1}(s₁) and a standard deviation σ₁=f_{σ1}(s₁) can be used. Correspondingly, multi-variate normal distributions may be used for describing the distributions expected for the competing speakers. These may further consider statistical dependencies of the competing speakers. In the following, the speaker under consideration, i.e. the assumed speaker is designated with the index i, and the speakers corresponding to the N−1 remaining codebooks are designated as the competing speakers (with N codebooks in total). For the competing speakers, the mean value μ₂ and the variants Σ₂ characterizing the corresponding normal distributions can then be written as vectors:

$$\begin{matrix} {μ}_{2} = E \{ ( \begin{matrix}{l}_{1}^{{s}_{1}} ( {x}_{t} ) - {l}_{0} ( {x}_{t} ) \\ M \\ {l}_{i - 1}^{{s}_{1}} ( {x}_{t} ) - {l}_{0} ( {x}_{t} ) \\ {l}_{i + 1}^{{s}_{1}} ( {x}_{t} ) - {l}_{0} ( {x}_{t} ) \\ M \\ {l}_{N}^{{s}_{1}} ( {x}_{t} ) - {l}_{0} ( {x}_{t} )\end{matrix} ) \} & ( 3 ) \\ {\sum }_{2} = E \{ [ ( \begin{matrix}{l}_{1}^{{s}_{1}} ( {x}_{t} ) - {l}_{0} ( {x}_{t} ) \\ M \\ {l}_{i - 1}^{{s}_{1}} ( {x}_{t} ) - {l}_{0} ( {x}_{t} ) \\ {l}_{i + 1}^{{s}_{1}} ( {x}_{t} ) - {l}_{0} ( {x}_{t} ) \\ M \\ {l}_{N}^{{s}_{1}} ( {x}_{t} ) - {l}_{0} ( {x}_{t} )\end{matrix} ) - {μ}_{2} ] \cdot {[ ( \begin{matrix}{l}_{1}^{{s}_{2}} - {l}_{0} ( {x}_{t} ) \\ M \\ {l}_{i - 1}^{{s}_{2}} ( {x}_{t} ) - {l}_{0} ( {x}_{t} ) \\ {l}_{i + 1}^{{s}_{2}} ( {x}_{t} ) - {l}_{0} ( {x}_{t} ) \\ M \\ {l}_{N}^{{s}_{2}} ( {x}_{t} ) - {l}_{0} ( {x}_{t} )\end{matrix} ) - {μ}_{2} ]}^{T} \} & ( 4 )\end{matrix}$$

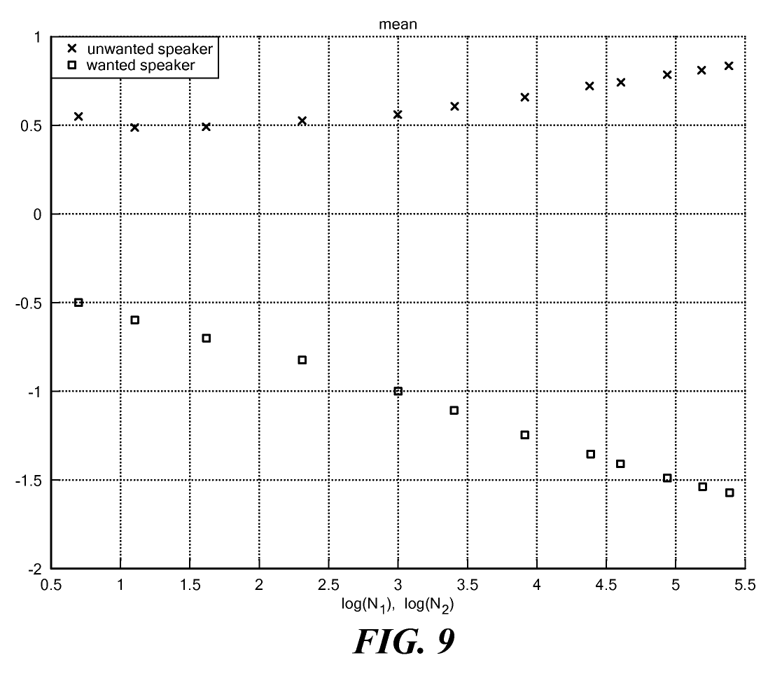

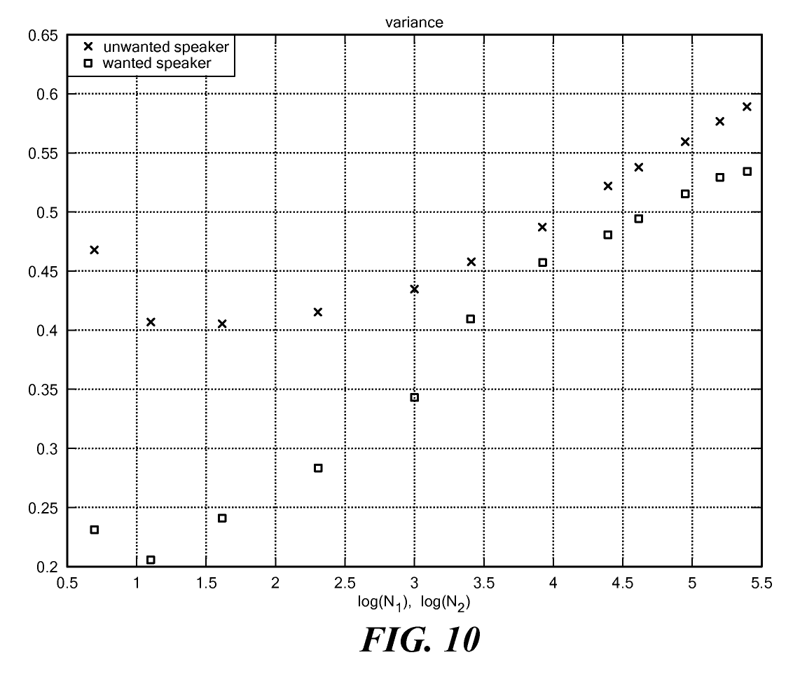

FIG. 9 and FIG. 10 compare the characterizing features μ, and Σ of the normal distributions, respectively, for an assumed speaker and a competing speaker. The comparison is made for the case where the models for both speakers have the same training state. As already indicated with respect to FIG. 8, the mean value for the distribution of the assumed speaker decreases with increasing training level, whereas the mean value for the competing speaker increases (FIG. 9). For lower training states, the variances show larger differences for both speakers, whereas for higher training states, the variances run substantially parallel.

The values shown in FIG. 9 and FIG. 10 may be approximated by curves, e.g. by a linear or polynomial fit, and may be provided in the speech recognition system as prior knowledge. Based on this knowledge and the retrieved training status, the corresponding likelihood score distribution can then be reconstructed. As soon as the values for μ and Σ are known, the logarithmic likelihood difference determined for an utterance for a particular codebook can be inserted into the corresponding normal distribution as a function value, and the corresponding probability is obtained.

Another possibility is to train multilayer perceptrons (MLPs) for representing the parameters μ and Σ. As an example, two MLPs may be trained which calculate the individual elements of the mean vector μ and the covariance matrix Σ for a given pair s₁ and s₂ of training states of competing speakers. For an inversion of the covariance matrix, a generalized inverse or pseudo inverse may be used.

Accordingly, the method of the present embodiment provides an efficient method of obtaining an expected likelihood distribution for a codebook. The expected likelihood score distribution may not only be based on training values of codebooks, but also on other parameters, such as the length of the utterance or a signal to noise ratio of the sound signal corresponding to the utterance. Further, different expected distributions can be provided for different individual speakers.

Now turning back to FIG. 3, a transition probability for a transition between a speaker of a preceding utterance and a speaker of the current utterance may be determined in step 204. The transition probability can be determined on the basis of prior knowledge and current or external information. Examples of information considered in the determination of the transition probabilities are given above. Again, the transition probability may be used to finetune the frequency with which speaker changes are detected. Step 204 is optional, the transition probabilities do not necessarily need to be considered at the second stage already. They can be considered in the third stage described with respect to FIG. 4, e.g. together with a transition probability to the speaker of a subsequent utterance.

Taking the training status and possibly the transition probability into account, a probability is determined for each speaker, i.e. for each corresponding codebook in step 205. For a particular codebook, i.e. for a particular assumed speaker, the probability may then comprise a probability term for the assumed speaker determined on the basis of the lower diagram of FIG. 8, and a probability term for the competing speakers determined on the basis of the upper diagram shown in FIG. 8. It may further comprise a probability term for the transition probability. In the following, the probability determined for the codebook is considered a posteriori probability.

The determination of the posteriori probability for a codebook for an utterance will be described in detail in the following. For an assumed speaker iₜ, and with the presence of the competing speakers iₜ₋₁, the probability that it produced the likelihood values l₀, l₁, . . . , l_{N} for the utterance xₜ at time t is to be determined. In the following considerations, the training states s₁ and s₂ are omitted for reasons of clarity. By using the Bayes-theorem, a posteriori probability can be determined for the speaker to:

$$p ( {i}_{t} \vert {i}_{t - 1} , {l}_{0} ( {x}_{t} ) , {l}_{1} ( {x}_{t} ) , … , {l}_{N} ( {x}_{t} ) ) = \frac{p ( {l}_{1} ( {x}_{t} ) , … , {l}_{N} ( {x}_{t} ) \vert {i}_{t} , {i}_{t - 1} , {l}_{0} ( {x}_{t} ) )}{p ( {l}_{0} ( {x}_{t} ) , … , {l}_{N} ( {x}_{t} ) )} \cdot p ( {i}_{t} , {l}_{0} ( {x}_{t} ) \vert {i}_{t - 1} ) \qquad ( 5 )$$

As can be seen from the above expression, the speaker iₜ₋₁ of the preceding utterance is considered. An analogue expression can be found for the “backward decoding” considering the speaker iₜ₊ᵢ of a subsequent utterance, as will be mentioned later with respect to the third stage. Assuming that the preceding speaker iₜ₋₁ does not have an influence on the present likelihood score, equation 5 can be amended to

$$p ( {i}_{t} \vert {i}_{t - 1} , {l}_{0} ( {x}_{t} ) , {l}_{1} ( {x}_{t} ) , … , {l}_{N} ( {x}_{t} ) ) = \frac{p ( {l}_{1} ( {x}_{t} ) , … , {l}_{N} ( {x}_{t} ) \vert {i}_{t} , {l}_{t} ( {x}_{t} ) )}{p ( {l}_{1} ( {x}_{t} ) , … , {l}_{N} ( {x}_{t} ) )} \cdot p ( {l}_{0} ( {x}_{t} ) \vert {i}_{t} ) \cdot p ( {i}_{t} \vert {i}_{t - 1} ) \qquad ( 6 )$$

The term p(l₀(xₜ)I iₜ) can be considered prior knowledge about the absolute likelihood score of the standard codebook and can be considered statistically independent from the speaker under consideration.

Accordingly, the term does not comprise information on the current speaker, it can simply be used as a normalizing factor. Thus, the following equation is obtained:

$$p ( {i}_{t} \vert {i}_{t - 1} , {l}_{0} ( {x}_{t} ) , {l}_{1} ( {x}_{t} ) , … , {l}_{N} ( {x}_{t} ) ) = \frac{p ( {l}_{1} ( {x}_{t} ) , … , {l}_{N} ( {x}_{t} ) \vert {i}_{t} , {l}_{0} ( {x}_{t} ) )}{const .} p ( {i}_{t} \vert {i}_{t - 1} ) \qquad ( 7 )$$

The normalizing constant can be obtained by a normalization of the posteriori probability p to a value of 1. In the following expression, the abbreviations

1ᵢ(xₜ)=(l₁(xₜ), . . . , lᵢ₋₁(xₜ),lᵢ₊₁(xₜ), . . . , l_{N}(xₜ)) (8)

1(xₜ)=(l₁(xₜ), . . . , l_{N}(xₜ)) (9)

will be used. Due to the observations made with respect to FIG. 7, it can be assumed that the likelihood scores of the assumed speaker are statistically independent of the likelihood scores of the competing speakers. Accordingly, the following expression can be obtained for the posteriori probability:

$$p ( {i}_{t} \vert {i}_{t - 1} , {l}_{0} ( {x}_{t} ) , {1}_{{i}_{t}} ( {x}_{t} ) ) = p ( {i}_{t} \vert {i}_{t - 1} ) \cdot p ( {l}_{{i}_{t}} ( {x}_{t} ) \vert {i}_{t} , {l}_{0} ( {x}_{t} ) ) \cdot \frac{p ( {1}_{{i}_{t}} ( {x}_{t} ) \vert {i}_{t} , {l}_{0} ( {x}_{t} ) )}{const .} \qquad ( 10 )$$

As mentioned above, this equation comprises a first probability term for transition probabilities, a second probability term for the probability of finding the likelihood value obtained for the assumed speaker, and a third probability term for finding the likelihood values if the remaining speakers are assumed to be competing speakers.

Accordingly, p(lᵢ_{ₜ}(xₜ)|iₜ,l₀(xₜ)) corresponds to the one-dimensional normal distribution with the parameters and Σ1 for the assumed speaker, whereas p(1ᵢ_{ₜ}(xₜ)|iₜ,l₀(xₜ)) corresponds to the multivariate normal distribution with the parameters μ2, Σ2 of the competing speakers. These probability terms can thus be expressed as

p(lᵢ_{ₜ}(xₜ)|iₜ,l₀(xₜ))=N(lᵢ_{ₜ}(xₜ)−l₀(xₜ)|μ₁,σ₁) (11)

p(lᵢ_{ₜ}(xₜ)|iₜ,l₀(xₜ))=N(lᵢ_{ₜ}(xₜ)−l₀(xₜ)·1|ρ₂,Σ₂) (12)

wherein 1 is a vector of the dimension N−1, with all elements equal to 1.

The remaining factor p(iₜ|iₜ₋₁) is a transition probability which can be determined on the basis of external information about a speaker change. The consideration of this factor provides a simple means for integrating external knowledge in form of a probability, without the need to change the modeling of the normal distributions. This is a great advantage due to its flexibility.

It should be clear that the above described determination of the posteriori probability does not need to be performed at the second state, i.e. as indicated in FIG. 3, but may be performed at the third stage, after several utterances were recorded, i.e. in step 300. Further, as mentioned above, a posteriori probability may also be determined in step 205 which does not take the transition probability into account.

In the next step 206, the codebook having the highest probability for the utterance is determined. As the training states of the codebooks were considered, a meaningful comparison between the probabilities for the different codebooks becomes possible. Accordingly, the determination of the speaker of the utterance based on the probabilities is generally more reliable than the determination on the basis of the absolute likelihood values. As the speaker of the utterance can be determined with a relatively high confidence, an adaptation of the feature vector extraction can be performed in accordance with the determined speaker in step 207. The adaptation may comprise the adjustment of speaker dependent parameters of the feature vector extraction. It should be noted that although such an adaptation of the feature vector extraction can improve the speech recognition performance, an incorrect adaptation is not critical, as it may be changed again for a subsequent utterance. Basing the adaptation of the feature extraction on the probabilities determined for the codebooks is particularly useful in cases, where the characteristics of the recorded sound signal experience a considerable change, e.g. when the recording of an utterance is changed from a built-in microphone to a headset or the like. As the likelihood scores can be compared to expected likelihood score distributions for individual speakers, said distributions each being determined by a characteristic μ and Σ, it is still possible to determine a meaningful probability for each codebook, whereas the comparison of absolute likelihood values would not allow the system to draw a conclusion regarding speaker identity. An improvement in robustness and accuracy of a speaker determination can thus be achieved.

In other embodiments, the adaptation of the feature vector extraction may simply be performed based on the absolute likelihood values for the individual codebooks.

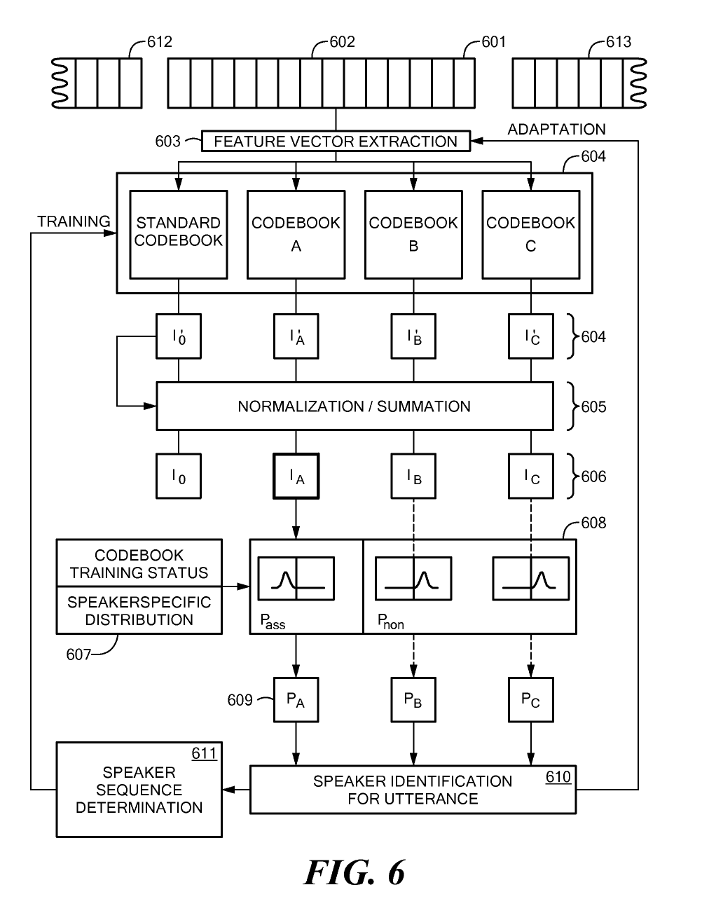

A schematic overview of the method of the present embodiment is given in FIG. 6. The utterance 601 is divided into a number of frames 602. Note that the frames may overlap. A feature vector extraction 603 is performed on the frame 602, and the feature vectors obtained after the extraction are classified on the codebooks 604. Codebooks 604 comprise a standard codebook, as well as speaker adapted codebooks A, B and C. Likelihood scores are calculated for each features vector for each codebook. A summation and normalization 605 of the likelihood scores 604 for the utterance 601 can be performed, e.g. by summing the likelihood scores for each codebook and normalizing them with the likelihood score for the standard codebook. By taking the logarithm, the logarithmic likelihood differences 1606 are obtained. By using the prior knowledge 607, which may comprise the codebook training status or speaker specific likelihood score distributions, a probability can be determined for each codebook. In the example of FIG. 6, the probability for codebook A is determined, i.e. A is the assumed speaker and B and C are the competing speakers. Accordingly, the likelihood difference l_{A} is compared to the distribution for the assumed speaker, whereas l_{B} and l_{C} are compared to the likelihood score distributions for the competing speakers. As a result, the probability p_{A} 609 is obtained. For determining the probabilities p_{B} and p_{C}, the speakers B and C are taken as the assumed speaker, respectively. The sum of the resulting probabilities may then be normalized to 1. Whereas based on the likelihood scores 604, a speaker can be identified for a section of utterance 601, the probabilities 609 can be used to identify the speaker for the whole utterance 601. As indicated in the Figure, the result of the speaker identification can then be used to adapt the feature vector extraction 603. Further, the probabilities obtained are used for determining a sequence of speakers corresponding to the sequence of utterances 612, 601 and 613. It should be clear that such a sequence of utterances may comprise more than just three utterances. Based on the result of the speaker sequence determination 611, a training of the codebooks 604 can be performed, or new codebooks can be generated.

The identification of the sequence of speakers is described in more detail with respect to FIG. 4. Further utterances are recorded in step 301 and processed correspondingly, i.e. as described with respect to FIGS. 2 and 3, in step 302. In particular, posteriori probabilities are determined for each speaker model for the recorded utterances. To improve the recognition of the sequence of speakers, the processing is delayed for a predetermined number of utterances. If the predetermined number of utterances is reached in step 303, a search algorithm is used in step 304 to determine the best matching sequence of speakers based on the probabilities determined for the codebooks for the sequence of utterances. In the example of FIG. 4, a forward-backward decoding is performed for finding the most probable sequence of speakers. It should be clear that other search algorithms may also be used, such as a Viterbi search algorithm, or a simple forward or backward decoding.

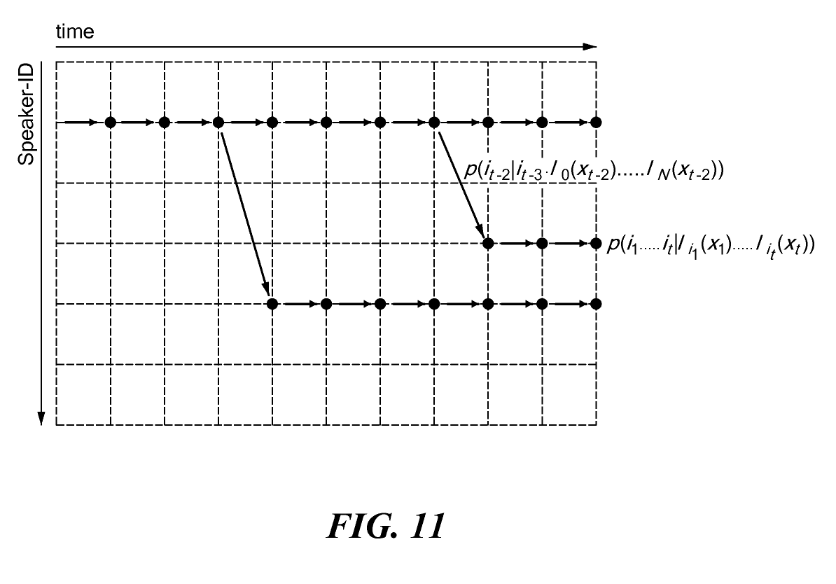

In the following, a detailed example will be given on how such a decoding can be performed. As mentioned above, a probability that the utterance corresponds to a particular speaker or codebook was determined for each utterance, which is similar to an HMM model wherein the speaker is the hidden state, and the observed likelihood scores are produced with a certain probability by each speaker (“emission probability”). Further, a transition probability to a preceding and a subsequent speaker can be determined, as shown with respect to equation 10, which shows the case for a transition to a preceding speaker and can similarly be adapted for a subsequent speaker. The path through the different states having the highest probability is to be found. This is schematically illustrated in FIG. 11, which indicates a transition probability for a forward transition from one speaker ID to another, as well as a posteriori probability for a particular speaker ID. Note that FIG. 11 is an example of a forward decoding corresponding to a Viterbi algorithm.

As an example, three speakers i_{1,2,3} and a sequence of three utterances x_{1,2,3} are assumed. The probability p(i₃,i₂,i₁|x₁,x₂,x₃) that the sequence of utterances was produced by a certain sequence of speakers has to be found.

By using a forward decoding algorithm, this probability is determined on the basis of knowledge about the current utterance and the preceding utterance. This can be performed incrementally. By applying the Bayes-theorem, the probability can be written as:

$$\begin{matrix}{p}_{v} ( {i}_{3} , {i}_{2} , {i}_{1} \vert {x}_{1} , {x}_{2} , {x}_{3} ) = p ( {i}_{3} \vert {i}_{2} , {i}_{1} , {x}_{1} , {x}_{2} , {x}_{3} ) \cdot \\ p ( {i}_{2} , {i}_{1} \vert {x}_{1} , {x}_{2} , {x}_{3} ) \\ = p ( {i}_{3} \vert {i}_{2} , {i}_{1} , {x}_{1} , {x}_{2} , {x}_{3} ) \cdot ( 14 ) \\ p ( {i}_{2} \vert {i}_{1} , {x}_{1} , {x}_{2} , {x}_{3} ) \cdot \\ p ( {i}_{1} \vert {x}_{1} , {x}_{2} , {x}_{3} )\end{matrix} \qquad ( 13 )$$

As only a transition between neighboring points in time is considered, i.e. between neighboring utterances, which corresponds to a first order Markov chain, the expression can be simplified to

pᵥ(i₃,i₂,i₁|x₁,x₂,x₃)=p(i₃|i₂,x₂,x₃)·p(i₂|i₁,x₁,x₂)·p(i₁|x₁) (15)

Application of the Bayes-theorem to the last factor gives

$$p ( {i}_{1} \vert {x}_{1} ) = p ( {x}_{1} \vert {i}_{1} ) \cdot \frac{p ( {i}_{1} )}{p ( {x}_{1} )} = p ( {x}_{1} \vert {i}_{1} ) \cdot \frac{p ( {i}_{1} )}{{\sum }_{{i}_{1}} p ( {x}_{1} \vert {i}_{1} ) \cdot p ( {i}_{1} )} . \qquad ( 16 )$$

In its most general form, the forward decoding represents the probability p(i_{1:t}/x_{1:t}), wherein iₜ₁ is the probability for the speaker i at time t. The expression i_{1:t-1} and x_{1:t} are abbreviations for i₁, . . . , iₜ₋₁ and xₜ, . . . , xₜ. The probability can thus be determined to

$$p ( {i}_{t} \vert {i}_{1 : t - 1} , {x}_{1 : t} ) = \frac{p ( {i}_{1 : t} \vert {x}_{1 : t} )}{p ( {i}_{1 : t - 1} )} \qquad ( 17 )$$

which is only dependent on knowledge about the current and past utterances. In particular for the first utterances of a sequence, the probability can thus not be determined with a high confidence.

A backward decoding, which may also be applied, uses a reverse processing, which starts with the last utterance. Only knowledge about the subsequent utterances with respect to the utterance under consideration it taken into account. This implies that the scores and the data required for speaker adaptation using these utterances has to be stored in a buffer, before the sequence of utterances is decoded. Similar to the above example, the following expression can be obtained for three utterances:

pᵣ(i₃,i₂,i₁|x₁,x₂,x₃)=p(i₁|i₂,x₁,x₂)·p(i₂|i₃,x₂,x₃)·p(i₃|x₃) (18)

Again applying the Bayes-theorem the last factor of the above equation can be determined to

$$p ( {i}_{3} \vert {x}_{3} ) = p ( {x}_{3} \vert {i}_{3} ) \cdot \frac{p ( {i}_{3} )}{p ( {x}_{3} )} = p ( {x}_{3} \vert {i}_{3} ) \cdot \frac{p ( {i}_{3} )}{{\sum }_{{i}_{3}} p ( {x}_{3} \vert {i}_{3} ) \cdot p ( {i}_{3} )} \qquad ( 19 )$$

With T indicating the point of time of the last utterance, the probability can be written in the most general form as

$$p ( {i}_{t} \vert {i}_{t + 1 : T} , {x}_{t : T} ) = \frac{p ( {i}_{t : T} \vert {x}_{t : T} )}{p ( {i}_{t + 1 : T} )} \qquad ( 20 )$$

Backward decoding thus only considers information about future utterances. For ensuring a reliable determination of the sequence of speakers, it is beneficial to use a forward-backward decoding method. In case of a first order Markov chain, this can be achieved by a simple multiplication and a new scaling of the probabilities. For a certain time t₁, this can be expressed as follows:

$$p ( {i}_{{t}_{1}} \vert {i}_{1 : t : T , t \neq {t}_{1}} , {x}_{1 : t : T} ) = \frac{p ( {i}_{{t}_{1}} \vert {i}_{1 : {t}_{1} - 1} , {x}_{1 : {t}_{1}} ) \cdot p ( {i}_{{t}_{1}} \vert {i}_{{t}_{1} + 1 : T} , {x}_{{t}_{1} : T} )}{p ( {x}_{t} \vert {i}_{{t}_{1}} ) \cdot p ( {i}_{{t}_{1}} )} . p ( {x}_{{t}_{1}} ) \qquad ( 21 )$$

By using the above expression, the probability that a speaker originated the utterance at time t₁ can be determined by using the knowledge about the past and the future utterances. Yet, it should be noted that the identity of the speakers of the preceding and subsequent utterances is not known or is at least uncertain. Accordingly, all paths have to be considered which assume the speaker iₜ₁ at time t₁. Summation over all paths leads to the expression

$$p ( {i}_{{t}_{1}} \vert {x}_{1 : t : T} ) = {\sum }_{allpaths} \frac{p ( {i}_{{t}_{1}} {i}_{1 : {t}_{1} - 1} \vert {x}_{1 : {t}_{1}} ) \cdot p ( {i}_{{t}_{1}} , {i}_{{t}_{1} + 1 : T} \vert {x}_{{t}_{1} : T} )}{p ( {x}_{t} \vert {i}_{{t}_{1}} ) \cdot p ( {i}_{{t}_{1}} )} \cdot p ( {x}_{{t}_{1}} ) \qquad ( 22 )$$

One advantage of this forward-backward decoding as used in the present embodiment is that for each point in time, a discrete posteriori probability is used for the speaker both in the forward as well as in the backward branch. There discrete probabilities are easier to interpret than the probabilities in a conventional decoding method, and a memory overflow can be prevented. Further, the whole history can implicitly be considered in the forward path.

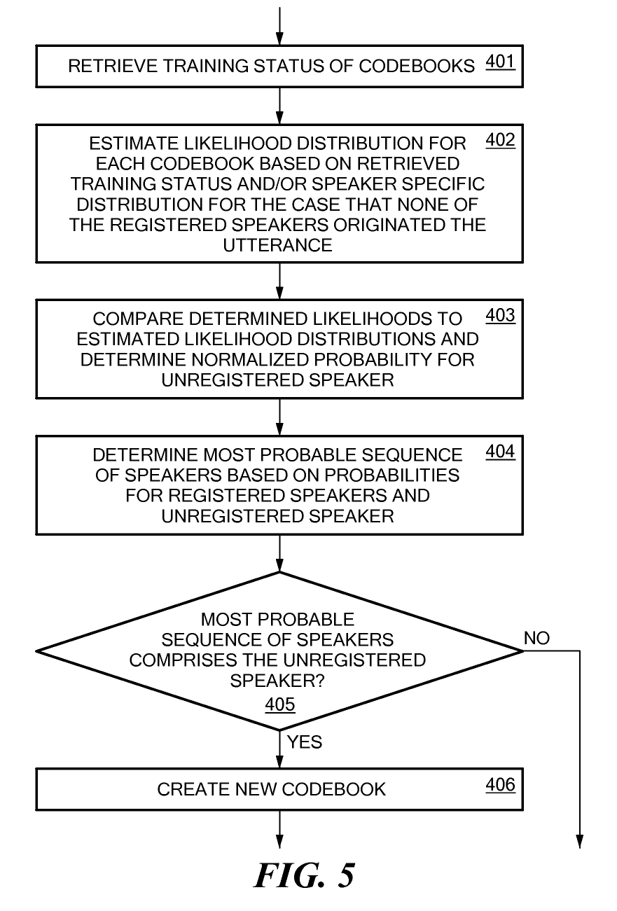

By using the expressions of equation 10, and a corresponding expression for a backward path implementing a transition probability for a subsequent speaker, a Viterbi decoding analogue to equations 15 and 18 may also be performed for finding the sequence of speakers corresponding to the sequence of utterances. As the approach of the present embodiment considers the transition probability to the preceding and the subsequent speaker, which may be determined in accordance with external information, a great flexibility of the decoding procedure can be achieved. This is an advantage over prior approaches, which used a Viterbi search based on likelihood scores for utterances. By using posteriori probabilities as given in equation 10, the comparison of a speaker under consideration with the remaining speakers can be based on a product of a model for the assumed speaker and of a model for the respective competing speaker. This approach is independent on the number of speakers, as an additional speaker only results in an increase of the dimension of the multivariate normal distribution of the competing speakers. The addition of a new speaker will be described in more detail with respect to FIG. 5 further below.

By using the posteriori probabilities of equation 10 and a corresponding probability considering a subsequent speaker, a posteriori probability for a whole sequence of utterances can be found based on equation 21. Using a forward-backward decoding based on equation 21 generally achieves better results than using a Viterbi Algorithm based on the same equation. The decoding can be performed along the lines of the Baum-Welsh-Algorithm. As the Baum-Welsh-Algorithm is well known to a person skilled in the art, it will not be described in detail here. Based on equation 22, the following iterations are obtained:

$$\begin{matrix}p ( {i}_{t} \vert l ( {x}_{0} ) , … , l ( {x}_{T} ) ) = {f}_{t} ( {i}_{t} , l ( {x}_{t} ) ) \cdot {b}_{t} ( {i}_{t} , l ( {x}_{t} ) ) \cdot \frac{p ( {x}_{t} )}{p ( {x}_{t} \vert {i}_{t} ) \cdot p ( {i}_{t} )} & ( 23 ) \\ {f}_{t} ( {i}_{t} , l ( {x}_{t} ) ) = {\sum }_{i = {1}_{t}} {f}_{t - 1} ( {i}_{t - 1} , l ( {x}_{t - 1} ) ) \cdot p ( {i}_{t} \vert {i}_{t - 1} , l ( {x}_{t} ) ) & ( 24 ) \\ {b}_{t} ( {i}_{t} , l ( {x}_{t} ) ) = {\sum }_{{i}_{t + 1}} {b}_{t + 1} ( {i}_{t + 1} , l ( {x}_{t + 1} ) ) \cdot p ( {i}_{t} \vert {i}_{t + 1} , l ( {x}_{t} ) ) & ( 25 ) \\ {f}_{- 1} ( {i}_{- 1} , l ( {x}_{- 1} ) ) = 1 & ( 26 ) \\ {b}_{T + 1} ( {i}_{T + 1} , l ( {x}_{T + 1} ) ) = 1 & ( 27 )\end{matrix}$$

By using not only the preceding utterance, but also subsequent utterances, the confidence of the decision can be increased. To achieve this increase in confidence, the final determination of the sequence of speakers has to be delayed. As an example, the final determination of the speaker of an utterance based on a sequence of utterances may be delayed for a fixed predetermined number of utterances. Turning back to FIG. 4, the sequence of speakers having the highest probability of corresponding to the sequence of utterances is determined in step 305. As the speaker can be determined with a high confidence, a training of the corresponding codebook can be performed with the utterance in step 306. As mentioned above, the training may be performed by adapting the multivariate normal distributions of the codebook to the utterance. If for particular utterances, a high posteriori probability is already determined, e.g. above a certain threshold value indicating a high confidence of speaker determination, the training may already be performed prior to determining said sequence of speakers, i.e. without delay. If a particularly low posteriori probability is found for a particular utterance, i.e. below a threshold value, the utterance may be rejected and not used for training, or a whole sequence of utterances may be rejected if the probability for the whole sequence is below a threshold value. A training of the codebooks with an incorrect utterance can thus be prevented.

It should be clear that there are a large number of modifications which may be made to the method without leaving the scope of the invention. As an example, forward decoding may be performed based on equation 10, with the feature vector extraction being adapted in accordance with the result of the forward decoding.

Turning now to FIG. 5, the creation of a new codebook is illustrated. After retrieving the training status of the codebooks in step 401, all codebooks are considered as competing speakers, and accordingly, an expected likelihood distribution for each codebook for the case of a competing speaker is retrieved in step 402. The distributions may again be based on the training status and/or on speaker specific distributions of likelihood scores. The likelihood scores determined for the codebooks are compared to the retrieved likelihood score distributions in step 403, and a normalized probability is determined based on the comparison in step 404. As all speakers are considered as competing speakers, this corresponds to the determination of a probability for an unregistered speaker. It can thus be based on equation 12. Based on the probability for the unregistered speaker, it can now be determined whether a new codebook is to be created. This can be performed by comparing the probability to a threshold value, as indicated in step 405. Other possibilities include the comparison of the probability for the unregistered speaker to the probabilities for the registered speakers and the like. If the probability is above the threshold value in decision step 406, the new codebook is created in step 407. This codebook may be trained by the utterance for which the unregistered speaker was detected. If it is not above the threshold value in step 406, no new codebook is created, and the method continues, e.g. by determining a sequence of speakers as described with respect to FIG. 4. The creation of new codebooks may also be based on the results of the sequence of speaker determination of FIG. 4. A new codebook may e.g be created if no speaker can be determined for an utterance with high confidence, or the creation may be based on absolute likelihood values for the codebooks, e.g. if these are below a threshold value.

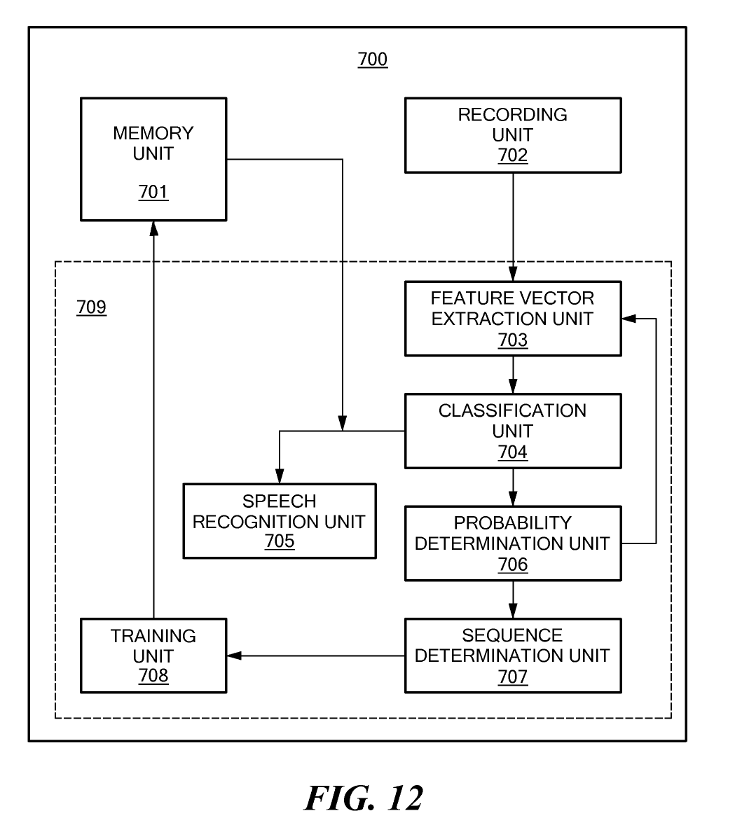

FIG. 12 schematically shows an electronic device 700 comprising a speech recognition system with automatic speaker detection and speaker model training Device 700 may for example be implemented as a portable navigation device, a dashboard mounted navigation device or entertainment system for a vehicle, a person digital assistant, a mobile telephone, a portable computer and the like. Device 700 comprises a memory unit 701 which stores a plurality of speaker models in form of a standard codebook and plural user adapted codebooks. Unit 701 may comprise any type of memory, such as random access memory, flash memory, a harddrive and the like. Recording unit 702 is adapted to record an utterance, and may thus comprise a microphone and an analogue to digital converter. Feature vector extraction uni 703 determines feature vectors for time frames of a recorded utterance, as described above. Unit 703 interfaces classification unit 704, which classifies the feature vectors according to the codebooks stored in memory unit 701. Results of the classification are supplied to speech recognition unit 705, which performs a speech recognition using e.g. acoustic models, such as HMMs, a recognition vocabulary and a language model. Likelihood scores obtained in classification unit 704 are then supplied to probability determination unit 706, which determines a posteriori probability for the utterance as described above. In accordance with the speaker determined based on the posteriori probability, the feature vector extraction unit 703 may be adapted to the particular speaker. After a predetermined number of utterances recorded and buffered, e.g. in memory unit 701, the sequence determination unit 707 determines the most probable sequence of speakers for the buffered sequence of utterances, based on the posteriori probabilities determined for the utterances. If sequence determination unit 707 determines the sequence of speakers with a high enough confidence, the results are supplied to training unit 708, which trains the codebooks stored in memory unit 701 with the corresponding utterances. As such, the functional units of device 700 may implement any of the above described methods. The functional units 703 to 708 may be implemented as software code portions running on a processing unit 709 of device 700. With respect to speaker recognition, device 700 can thus achieve the advantages as outlined above.

While specific embodiments of the invention are disclosed herein, various changes and modifications can be made without departing from the scope of the invention. As an example, normal distributions are used in the above description, yet it is also possible to use other statistical models for modelling the likelihood score distributions as well as the codebooks. The present invention enables a comparison of codebooks of different training levels. Further, new speakers can be added to the system without adapting the speaker recognition method. The above method further allows the use of transition probabilities for speaker transitions, wherein external information, such as from a beamformer or from a restart of the system can be considered, without having to adapt the speaker recognition method. Further, as the number of the speakers (or states) of the system does not need to be known prior to operation, it is more flexible than a modelling of the speakers with Hidden Markov Models and a Viterbi decoding. New speakers can thus be implemented into the system without the need to retrain the whole system. Also, the system is more flexible than neural network approaches, which are generally based on a fixed number of input parameters. The delayed determination of the sequence of speakers enables the determination of a speaker with a high confidence, which enables an automatic training of the codebooks with a reduced risk of codebook deterioration. This is particularly the case when an utterance or a sequence of utterances is rejected for training based on a low posteriori probability determined for the utterance or for the sequence of utterances. By improving the speaker recognition and by providing an automated training of the codebooks, feature vector extraction and classification can be improved, resulting in a better speech recognition performance.

Although the previously discussed embodiments of the present invention have been described separately, it is to be understood that some or all of the above described features can also be combined in different ways. The discussed embodiments are not intended as limitations but serve as examples illustrating features and advantages of the invention. The embodiments of the invention described above are intended to be merely exemplary; numerous variations and modifications will be apparent to those skilled in the art. All such variations and modifications are intended to be within the scope of the present invention as defined in any appended claims.

It should be recognized by one of ordinary skill in the art that the foregoing methodology may be performed in a signal processing system and that the signal processing system may include one or more processors for processing computer code representative of the foregoing described methodology. The computer code may be embodied on a tangible computer readable storage medium i.e. a computer program product.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an embodiment of the present invention, predominantly all of the reordering logic may be implemented as a set of computer program instructions that is converted into a computer executable form, stored as such in a computer readable medium, and executed by a microprocessor within the array under the control of an operating system.

Computer program logic implementing all or part of the functionality previously described herein may be embodied in various forms, including, but in no way limited to, a source code form, a computer executable form, and various intermediate forms (e.g., forms generated by an assembler, compiler, networker, or locator.) Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL.).

What is claimed is:

1. A method of recognizing a speaker of an utterance in a speech recognition system, comprising:
determining within a processor a likelihood score for a plurality of speaker models for different speakers, the speaker models stored within memory, the likelihood score indicating how well the speaker model corresponds to the utterance; and
for each of the plurality of speaker models, determining within the processor a probability that the utterance originates from the speaker corresponding to the speaker model,
wherein determining the probability for a speaker model is based on the likelihood scores for the speaker models and takes prior knowledge about the speaker model into account;
wherein the prior knowledge comprises estimating a distribution of likelihood scores expected for a training state of the speaker model and comparing the likelihood score determined for the speaker model to the likelihood distribution expected for the training state of the speaker model.

2. A method of recognizing a speaker of an utterance in a speech recognition system, comprising:
determining within a processor a likelihood score for a plurality of speaker models for different speakers, the speaker models stored within memory, the likelihood score indicating how well the speaker model corresponds to the utterance; and
for each of the plurality of speaker models, determining a probability that the utterance originates from the speaker corresponding to the speaker model,
wherein the determination of the probability for a speaker model is based on the likelihood scores for the speaker models and takes a prior knowledge about the speaker model into account;
wherein the prior knowledge for a particular speaker model comprises at least one of an expected distribution of likelihood scores for the particular training state of the speaker model and an expected distribution of likelihood scores for the particular speaker model.

3. The method according to claim 1, wherein the distribution of likelihood scores expected for the training state is estimated by a multilayer perceptron trained on likelihood score distributions obtained for different training states of speaker models, wherein the multilayer perceptron returns parameters of a distribution of likelihood scores for the given particular training state.

4. A method of recognizing a speaker of an utterance in a speech recognition system, comprising:
determining within a processor a likelihood score for a plurality of speaker models for different speakers, the speaker models stored within memory, the likelihood score indicating how well the speaker model corresponds to the utterance; and
for each speaker model, determining a probability that the utterance originates from the speaker corresponding to the speaker model,
wherein the determination of the probability for a speaker model is based on the likelihood scores for the speaker models and takes a prior knowledge about the speaker model into account;
wherein taking the prior knowledge into account comprises estimating a distribution of likelihood scores expected for the particular speaker model or for the gender of the speaker corresponding to the speaker model and comparing the likelihood score determined for the speaker model to the likelihood score distribution expected for said speaker model.

5. The method according to claim 1, wherein the estimation of the distribution of likelihood scores further considers at least one of a length of the utterance and a signal to noise ratio of the utterance.

6. The method according to claim 1, wherein the determining of the probability for a particular speaker model comprises:
comparing the likelihood score for the speaker model under consideration to a distribution of likelihood scores for the particular speaker model expected in case that the speaker under consideration is the originator of the utterance, the distribution of likelihood scores being determined based on the prior knowledge;
comparing the likelihood scores for the remaining speaker model each to a distribution of likelihood scores expected in case that the remaining speaker is not the originator of the utterance, the distribution of likelihood scores for the remaining speakers being based on the prior knowledge, and
determining the probability for the particular speaker model based on the comparisons.

7. The method according to claim 1, wherein the determination of the probability for a speaker model further considers a transition probability for a transition between the corresponding speaker to a speaker of a preceding and/or subsequent utterance.

8. The method according to claim 7, wherein the transition probability considers at least one of a change of a direction from which successive utterances originate, a shutdown or restart of the speech recognition system between successive utterances, and a detection of a change of a user of the speech recognition system.

9. The method according to claim 1, wherein the determination of the likelihood score for a speaker model for the utterance is based on likelihood scores of a classification of feature vectors extracted from the utterance on the speaker model, the classification result for at least one speaker model being used in a subsequent speech recognition step.

10. The method according to claim 9, wherein the utterance is continuously being processed, with the classification result of the speaker model yielding the highest average likelihood score for a predetermined number of feature vectors being supplied to the speech recognition step.

11. The method according to claim 1, wherein the utterance is part of a sequence of utterances, and wherein said probability is determined for each utterance in said sequence, the method further comprising the step of:
determining a sequence of speakers having the highest probability of corresponding to the sequence of utterances, the determination being based on the probabilities determined for the speaker models for the utterances,
wherein each probability for a speaker model for an utterance considers a transition probability for a transition to a speaker of a preceding utterance and/or a speaker of a subsequent utterance.

12. The method according to claim 11, wherein the most probable sequence of speakers corresponding to the sequence of utterances is determined by using a Viterbi search algorithm based on the probabilities determined for the speaker models for the utterances.

13. The method according to claim 11, wherein the most probable sequence of speakers corresponding to the sequence of utterances is determined by using a forward-backward decoding algorithm.

14. The method according to claim 11, further comprising the step of:
using an utterance of the sequence of utterances to train the speaker model of the speaker in the sequence of speakers corresponding to the respective utterance.

15. The method of claim 14, wherein the training is performed after said sequence of speakers is determined for a predetermined number of successive utterances or if the probability for a speaker model for an utterance exceeds a predetermined threshold value.

16. The method according to claim 1, wherein the comparing of the utterance to a plurality of speaker models comprises an extraction of feature vectors from the utterance, the method further comprising the step of adapting the feature vector extraction in accordance with the speaker model for which the highest probability is determined.

17. The method according claim 1, wherein the plurality of speaker models comprises a standard speaker model, the determination of the speaker model probabilities for the utterance being based on likelihood scores for the speaker models normalized by a likelihood score for the standard speaker model.

18. The method according to claim 1, wherein the determining of a probability for each speaker model comprises the determining of a probability for an unregistered speaker for which no speaker model exists, the probability being calculated by assuming that none of the speakers of the speaker models originated the utterance, the method further comprising the step of:
generating a new speaker model for the unregistered speaker if the probability for the unregistered speaker exceeds a predetermined threshold value or exceeds the probabilities for the other speaker models.

19. The method according to claim 1, further comprising the step of:
generating a new speaker model if the likelihood scores for said speaker models are below a predetermined threshold value.

20. The method according to claim 1, wherein the plurality of speaker models comprises for at least one speaker different models for different environmental conditions.

21. Speech recognition system adapted to recognizing a speaker of an utterance, the speech recognition system comprising:
a recording unit adapted to record an utterance;
a memory unit adapted to store a plurality of speaker models for different speakers, each model having an associated training state; and
a processing unit that:
compares the utterance to the plurality of speaker models;
determines a likelihood score for each speaker model, the likelihood score indicating how well the speaker model corresponds to the utterance; and
for each speaker model, determines a probability that the utterance originates from the speaker corresponding to the speaker model, wherein the determination of the probability for a speaker model is based on the likelihood scores for the speaker models and uses the training states of the speaker models.

22. A computer program product including a computer readable storage medium with computer executable code thereon for recognizing a speaker of an utterance in a speech recognition system, the computer code comprising:
computer code for determining a likelihood score for a plurality of speaker models for different speakers, the likelihood score indicating how well the speaker model corresponds to the utterance; and
computer code for determining for each of the plurality of speaker models a probability that the utterance originates from the speaker corresponding to the speaker model,
wherein the computer code for determining the probability for a speaker model is based on the likelihood scores for the speaker models and takes prior knowledge about the speaker model into account;
wherein the prior knowledge comprises estimating a distribution of likelihood scores expected for a training state of the speaker model and comparing the likelihood score determined for the speaker model to the likelihood distribution expected for the training state of the speaker model.

23. A computer program product including a computer readable storage medium with computer executable code thereon for recognizing a speaker of an utterance in a speech recognition system, the computer code comprising:
computer code for determining within a processor a likelihood score for a plurality of speaker models for different speakers, the speaker models stored within memory, the likelihood score indicating how well the speaker model corresponds to the utterance; and
computer code for determining for each of the plurality of speaker models, a probability that the utterance originates from the speaker corresponding to the speaker model,
wherein the computer code for determination of the probability for a speaker model is based on the likelihood scores for the speaker models and takes a prior knowledge about the speaker model into account;
wherein the prior knowledge for a particular speaker model comprises at least one of an expected distribution of likelihood scores for the particular training state of the speaker model and an expected distribution of likelihood scores for the particular speaker model.

24. The computer program product according to claim 22, wherein the distribution of likelihood scores expected for the training state is estimated by a multilayer perceptron trained on likelihood score distributions obtained for different training states of speaker models, wherein the multilayer perceptron returns parameters of a distribution of likelihood scores for the given particular training state.

25. A computer program product including a computer readable storage medium with computer executable code thereon for recognizing a speaker of an utterance in a speech recognition system, the computer code comprising:
computer code for determining within a processor a likelihood score for a plurality of speaker models for different speakers, the likelihood score indicating how well the speaker model corresponds to the utterance; and
computer code for determining a probability for each speaker model of the plurality of speaker models that the utterance originates from the speaker corresponding to the speaker model,
wherein the computer code for determining the probability for a speaker model is based on the likelihood scores for the speaker models and takes a prior knowledge about the speaker model into account;
wherein taking the prior knowledge into account comprises estimating a distribution of likelihood scores expected for the particular speaker model or for the gender of the speaker corresponding to the speaker model and comparing the likelihood score determined for the speaker model to the likelihood score distribution expected for said speaker model.

26. The computer program product according to claim 22, wherein the computer code for estimating the distribution of likelihood scores further considers at least one of a length of the utterance and a signal to noise ratio of the utterance.

27. A computer program product including a computer readable storage medium with computer executable code thereon for determining of the probability for a particular speaker model further comprises:
computer code for comparing the likelihood score for the speaker model under consideration to a distribution of likelihood scores for the particular speaker model expected in case that the speaker under consideration is the originator of the utterance, the distribution of likelihood scores being determined based on the prior knowledge;
comparing the likelihood scores for the remaining speaker model each to a distribution of likelihood scores expected in case that the remaining speaker is not the originator of the utterance, the distribution of likelihood scores for the remaining speakers being based on the prior knowledge, and
determining the probability for the particular speaker model based on prior knowledge, wherein the prior knowledge is at least one of an expected distribution of likelihood scores for the particular training state of the speaker model and an expected distribution of likelihood scores for the particular speaker model.

28. The computer program product according to claim 22, wherein the computer code for determining the probability for a speaker model further considers a transition probability for a transition between the corresponding speaker to a speaker of a preceding and/or subsequent utterance.

29. The computer program product according to claim 28, wherein the transition probability considers at least one of a change of a direction from which successive utterances originate, a shutdown or restart of the speech recognition system between successive utterances, and a detection of a change of a user of the speech recognition system.

30. The computer program product according to claim 22, wherein the determination of the likelihood score for a speaker model for the utterance is based on likelihood scores of a classification of feature vectors extracted from the utterance on the speaker model, the classification result for at least one speaker model being used in a subsequent speech recognition step.

31. The computer program product according to claim 30, wherein the utterance is continuously being processed, with the classification result of the speaker model yielding the highest average likelihood score for a predetermined number of feature vectors being supplied to the speech recognition step.

32. The computer program product according to claim 22, wherein the utterance is part of a sequence of utterances, and wherein said probability is determined for each utterance in said sequence, the computer code further comprising:
computer code for determining a sequence of speakers having the highest probability of corresponding to the sequence of utterances, the determination being based on the probabilities determined for the speaker models for the utterances,
wherein each probability for a speaker model for an utterance considers a transition probability for a transition to a speaker of a preceding utterance and/or a speaker of a subsequent utterance.

33. The computer program product according to claim 22, wherein the most probable sequence of speakers corresponding to the sequence of utterances is determined by using a Viterbi search algorithm based on the probabilities determined for the speaker models for the utterances.

34. The computer program product according to claim 22, wherein the most probable sequence of speakers corresponding to the sequence of utterances is determined by using a forward-backward decoding algorithm.

35. The computer program product according to claim 22, further comprising:
computer code for using an utterance of the sequence of utterances to train the speaker model of the speaker in the sequence of speakers corresponding to the respective utterance.
